(19) United States
(12) Patent Application Publication
(10) Pub. No.: US 2007/0250787 A1
(43) Pub. Date: Oct. 25, 2007

(54) Enhancing visual representation and other effects for application management on a device with a small screen

(76) Inventors: Hideya Kawahara, Moutain View, CA (US); Paul Byrne, Los Altos, CA (US); Frank E. Ludolph, Menlo Park, CA (US); Yoojin Hong, San Jose, CA (US); Curtis J. Sasaki, Sunnyvale, CA (US)

Correspondence Address: SUN MICROSYSTEMS INC.;C/O PARK, VAUGHAN & FLEMING LLP, 2820 FIFTH STREET, DAVIS, CA, 95618-7759, US

(21) Appl. No.: 11/409,192

(22) Filed: Apr. 21, 2006

(51) Int. Cl. G06F 17/00

(52) U.S. Cl. 715/782

(57) ABSTRACT

One embodiment of the present invention provides a system that uses three-dimensional (3D) and other rendering effects within a graphical display environment on a mobile device to enable a new application to be displayed while a currently-running application window remains visible within a main viewing area of a screen. During operation, the system receives a request to display a new application in the graphical display environment. Next, in response to the request, the system generates a slanted view of the currently-running application window by slanting the currently-running application window through a 3D rendering effect and moving the currently-running application window towards an edge of the screen to make room for the new application. Finally, the system displays the new application in a new display window next to the slanted view of the currently-running application window.

### RELATED APPLICATION

This application is related to a pending U.S. patent application, entitled, “Visual Representation and Other Effects for Application Management on a Device with a Small Screen,” by inventors Hideya Kawahara, Paul Byrne, Frank E. Ludolph, Yoojin Hong, Curtis J. Sasaki, and Eitaro Nishijima, having Ser. No. 11/159,951, and filing date 23 Jun. 2005 (Attorney Docket No. SUN05-0809).

### BACKGROUND

1. Field of the Invention

The present invention relates to user-interfaces for computer systems. More specifically, the present invention relates to a method and an apparatus that uses advanced graphics rendering capability to solve user interaction issues in selecting and running multiple applications through screens with physical size limitations.

2. Related Art

The Internet has made seamless access to information a common facet in the everyday life for millions of computer users. Advances in communications and computing technology have led to dramatic changes in both the way and the frequency with which people access information, and have led to an expectation that data should be accessible anywhere and at any time via mobile devices. In order to meet these expectations, mobile devices such as mobile phones, PDAs (Personal Digital Assistants), and car navigation systems have become increasingly more sophisticated. While such devices previously supported only a limited number of applications running serially, they have begun to support a larger number of applications, with multiple applications running concurrently.

Unfortunately, because of physical size limitations, these mobile devices have relatively small screens, which makes user interactions with such devices challenging. For example, due to this small screen size, individual mobile applications typically fill the entire screen. Consequently, when switching between two applications, these devices typically change the screen instantly to the new application without any transitional effect. This abrupt application switching can give the user an impression that the previous application has been terminated, even if it is still running in the background. As a result, the user might abandon the previously running application.

Furthermore, this small screen size also makes it hard for the user to access multiple applications that are installed to the device. Typically, when multiple applications are running concurrently on the device, the user can only actively interact with one of them using full-screen mode because of the limited screen real estate. Hence, it becomes particularly challenging if the user desires to simultaneously monitor changes or updates in one or more active background applications.

Ongoing hardware developments can potentially be used to solve these problems. The latest high-end mobile phones include a three-dimensional (3D) accelerator that provides a significant improvement in graphics rendering capability. Some of these high-end devices also include unique input mechanisms, such as a jog dial and touch screen, as well as advanced output mechanisms, such as stereo sound. Unfortunately, at present these advanced capabilities are not being used to help a user understand application status, other than just providing “eye candy.”

Hence, what is needed is a method and an apparatus that remedies the above-described user-application interaction issues on mobile devices with small screens.

### SUMMARY

One embodiment of the present invention provides a system that uses three-dimensional (3D) and other rendering effects within a graphical display environment on a mobile device to enable a new application to be displayed while a currently-running application window remains visible within a main viewing area of a screen. During operation, the system receives a request to display a new application in the graphical display environment. Next, in response to the request, the system generates a slanted view of the currently-running application window by slanting the currently-running application window through a 3D rendering effect and moving the currently-running application window towards an edge of the screen to make room for the new application. Finally, the system displays the new application in a new display window next to the slanted view of the currently-running application window.

In a variation on this embodiment, if the new application completes running before the currently-running application completes, then the system closes the new display window for the new application in the main viewing area of the screen. Next, the system restores the currently-running application window back to its original size, shape and position in the main viewing area of the screen.

In a variation on this embodiment, the new application is an interrupting application.

Another embodiment of the present invention provides a system that uses three-dimensional (3D) and other rendering effects within a graphical display environment on a mobile device to enable a second application which is displayed in the background of the graphical display environment to receive attention from a user who is interacting with a first application. During operation, the system displays a window for the first application in a main viewing area of the graphical display environment. Next, the system displays a scaled-down window for the second application in the graphical display environment. When the second application requires attention, the system then applies a 3D rendering effect to the displayed scaled-down window for the second application to alert the user that the second application requires attention.

In a variation on this embodiment, the system displays the scaled-down window for the second application in the graphical display environment next to the window for the first application in the main viewing area, wherein the scaled-down window is miniaturized.

In a variation on this embodiment, the system displays the scaled-down window for the second application in the graphical display environment so that the scaled-down window overlaps the window for the first application in the main viewing area, wherein the scaled-down window is translucent.

In a variation on this embodiment, the 3D rendering effect can include an animation action of the scaled-down window.

In a variation on this embodiment, the system uses a stereo sound effect associated with the location of the scaled-down window to alert the user that the second application requires attention.

In a variation on this embodiment, the system uses a vibration generator associated with the rendering effects to alert the user that the second application requires attention.

### BRIEF DESCRIPTION OF THE FIGURES

FIG. 1 illustrates the components of a sample mobile device in accordance with an embodiment of the present invention.

FIG. 2 illustrates the process of displaying user applications on the screen of a mobile device by utilizing three-dimensional (3D) rendering effects in accordance with an embodiment of the present invention.

FIGS. 3A, 3B, 3C, 3D, 3E, and 3F collectively illustrate the process of displaying a new application while a currently-running application occupies the entire display of the screen in accordance with an embodiment of the present invention.

FIG. 4 presents a flowchart illustrating the process of enabling a new application to be displayed while a currently-running application window remains visible on a mobile device screen in accordance with an embodiment of the present invention.

FIGS. 5A, 5B, 5C, 5D, 5E, and 5F collectively illustrate the process of enabling an application running in the background to receive attention from a user who is interacting with a currently-running application in the foreground of the display area in accordance with an embodiment of the present invention.

FIG. 6 presents a flowchart illustrating the process of enabling a concurrently-running application in the background to receive attention from the user who is interacting with a currently-running application in the foreground of the display area in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

The User-Interface of a Mobile Device

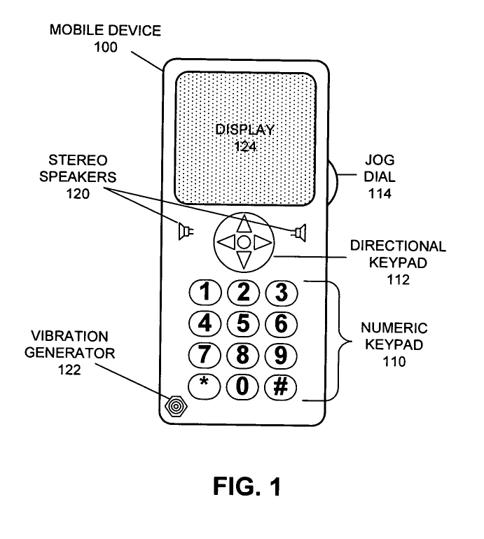

FIG. 1 illustrates the components of a sample mobile device 100 in accordance with an embodiment of the present invention. Device 100 can include a number of input mechanisms, including but not limited to, a numeric keypad 110, a directional keypad 112, and a jog dial 114. Mechanisms for generating output can include stereo speakers 120, a mechanical vibration generator 122, and a display screen 124. Device 100 can also include mechanisms to communicate with other devices or computer systems via a wired network or wireless network connection.

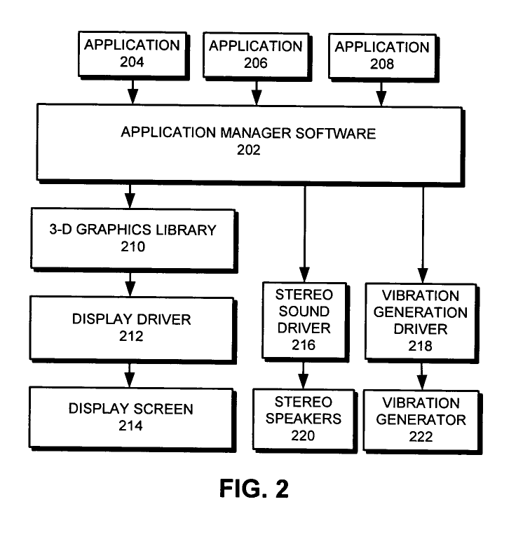

FIG. 2 illustrates the process of displaying user applications on the screen of a mobile device by utilizing three-dimensional (3D) rendering effects in accordance with an embodiment of the present invention. During this process, application manager software 202 manages the displaying of multiple user applications 204, 206, and 208 on the screen of mobile device 100, which involves managing the appearance and position of user application window on the screen. In particular, application manager software 202 utilizes a 3D graphics library 210 to render a 3D visual effect for a user application and presents the 3D visual effect to the display driver 212, which in turn displays the graphical output for the user application on display screen 214. The 3D graphics library can include, but is not limited to, OpenGL, OpenGL ES, and DirectX. Additionally, application manager software 202 can interact with other input and output device drivers to communicate with the user. The stereo-sound driver 216 and vibration-generation driver 218 send outputs associated with user applications 204, 206, and 208 to the stereo speakers 220 and vibration generator 222, respectively.

Displaying an Interrupting Application While Running an Application

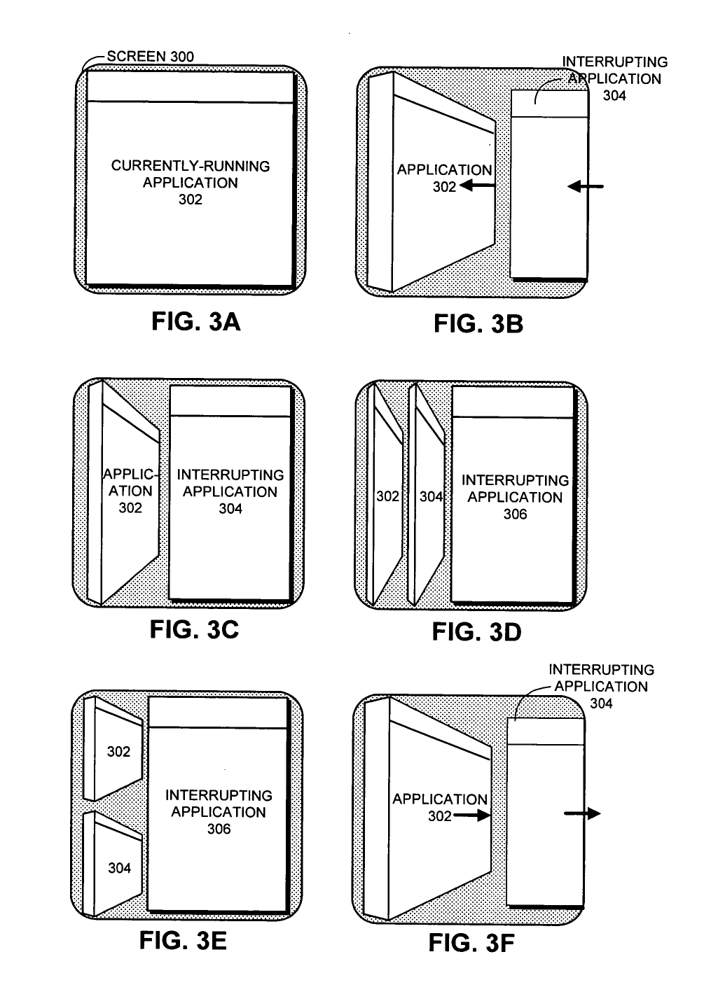

FIGS. 3A, 3B, 3C, 3D, 3E, and 3F illustrate the process of displaying a new application while a currently-running application occupies the entire display of the screen 300 in accordance with an embodiment of the present invention.

Note that the new application can be an interrupting application, such as an incoming phone call or the arrival of an SMS message that results in an interrupting dialog. In FIG. 3A, application 302 is actively running and occupying the entire display area of screen 300.

In FIG. 3B, an interrupting application 304 enters screen 300 from the right, while the currently-running application 302 gets pushed aside towards the left of the screen. While moving towards the left, the representation of currently-running application 302 changes from a 2D plane-view to a 3D slanted view through a 3D transformation which utilizes the 3D rendering capability of the mobile device. As interrupting application 304 takes up more display area, currently-running application 302 is scaled down continuously and becomes increasingly slanted. FIG. 3C illustrates that when the above animation completes, interrupting application 304 occupies the main display area of screen 300 while currently-running application 302 has a scaled-down 3D slanted view and remains clearly visible.

Note that the direction from which interrupting application 304 enters the screen can also include the left, the top and the bottom of screen 300. Alternatively, interrupting application 304 can enter the screen at an arbitrary angle with respect to an edge of the screen. Regardless of the direction, currently-running application 302 displays the 3D animation effect that the window is being pushed aside by the new application window, and becomes slanted.

FIGS. 3D and 3E illustrate two possible implementations for handling the case where a second interrupting application 306 arrives before completing the first interrupting application 304 in accordance with an embodiment of the present invention. Note that multiple running applications 302 and 304 are being displayed in this slanted manner along an edge of screen 300, while the main display area is occupied by the most-recent interrupting application 306. Again, the slanted views allow all of the applications to be viewed simultaneously.

FIG. 3F illustrates the process of restoring the currently-running application window 302 when the interrupting application 304 completes in accordance with an embodiment of the present invention. Note that the interrupting application window closes upon finishing, while the currently-running application window is restored to its original size, shape and position in the main screen. The associated animation effect can be achieved through the reversal of the operation illustrated in of FIG. 3B.

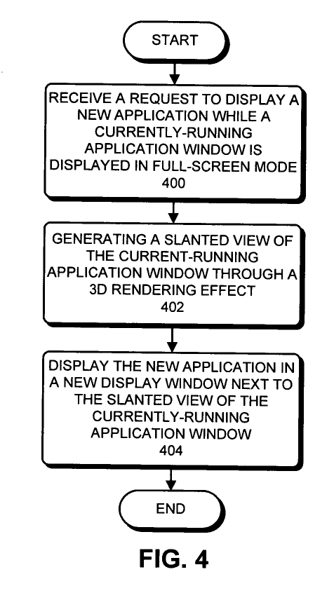

FIG. 4 presents a flowchart illustrating the process of enabling a new application to be displayed while a currently-running application window remains visible on a small screen in accordance with an embodiment of the present invention.

During operation, the system receives a request to display a new application on the small screen which has a graphical display environment, while a currently-running application is displayed in a full-screen mode (step 400). Next, in response to the request, the system generates a slanted view of the currently-running application window through a 3D rendering effect (step 402). By slanting the currently-running application window, the system condenses the window towards an edge of the screen to make room for the new application.

The system then displays the new application in a new display window next to the slanted window for the currently-running application (step 404). Note that the slanted view is sufficiently large to allow the contents of the current running application remain visible.

Enabling a Background Running Application to Receive Attention

3D display capability can also be used to monitor selected applications. For example, selected applications running in the background can be displayed in a scaled-down manner in the same screen as the currently-running application window. Although the user may not be able to understand the details of the scaled-down display, 3D animation effects can be applied to the scaled-down display for an application combined with other visual clues which make it easy to recognize that a status change has occurred in the application. The system can also expand the signaling application back into the central display area in full-screen form if necessary.

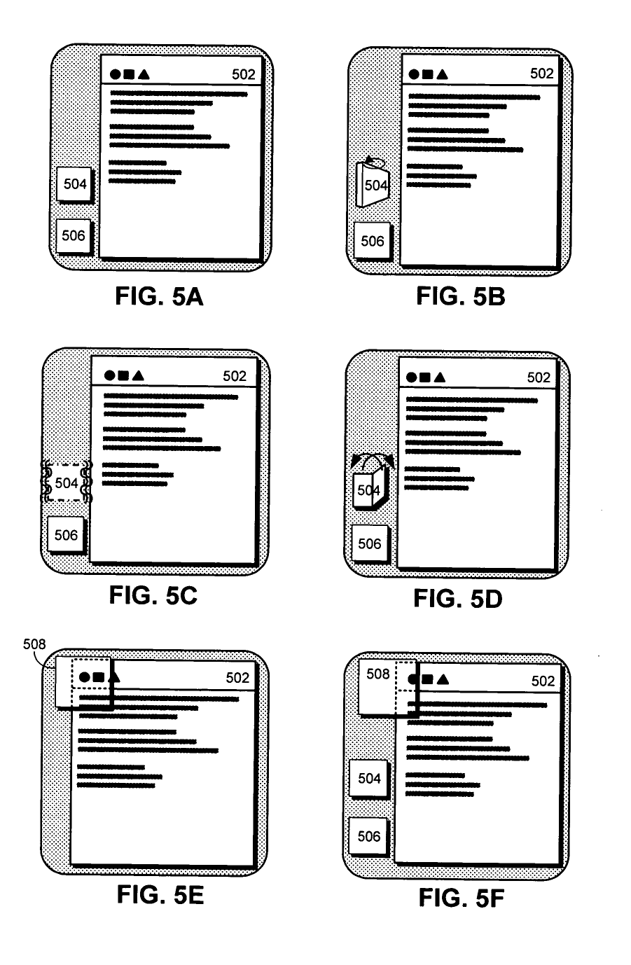

FIGS. 5A, 5B, 5C, 5D, 5E, and 5F collectively illustrate the process of enabling an application running in the background to receive attention from a user who is interacting with a currently-running application in the foreground of the display area in accordance with an embodiment of the present invention.

FIG. 5A illustrates three concurrently-running applications 502, 504, and 506, wherein applications 504 and 506 are running in the background and displayed next to foreground application window 502, which occupies the main display area. Note that both applications 504 and 506 are displayed in miniaturized windows next to foreground window 502. Also note that when applications 504 and 506 do not require attention from the user, their associated displays are stationary.

In one embodiment of the present invention, when application 504 needs attention from the user, it can generate a noticeable change in its associated display by utilizing a 3D animation effect.

For example, FIG. 5B illustrates a rotational motion applied to miniaturized window 504, wherein window 504 rotates around a specific axis in order to receive attention from the user. Furthermore, the rotation effect of window 504 can be combined with 3D lighting effect to enhance the visual cue to the user, for example, a brightness change (not shown) on window 504.

In another example, FIG. 5C illustrates a vibration effect applied to miniaturized window 504, wherein miniaturized window 504 displays a vibrating motion using a 3D animation in order to receive attention from the user. Furthermore, this vibration animation can be synchronized with the physical vibration mechanism of the device to enhance the visual cue to the user.

In yet another example, FIG. 5D illustrates a folding effect applied to miniaturized window 504, wherein miniaturized window 504 displays an animation of folding/opening actions in order to receive attention from the user. Note that miniaturized window 504 may be folded along any direction within the plane of miniaturized window 504.

In all scenarios illustrated in FIGS. 5B, 5C, and 5D, the 3D animation effects can be further enhanced with a stereo sound effect. In particular, the source of the stereo sound can be associated with the 3D location of the application window. Alternatively, the stereo sound can be used as a standalone sound effect, for example, to make a sound in which the sound source is flying into the screen. Note that the apparent 3D location of stereo sound source can be well-separated from the apparent 3D location of the currently-running application 502. This informs the user that an event that is unrelated to the currently-running application is occurring.

In one embodiment of the present invention, if the user desires to monitor a background application more closely, the system can display a scaled-down window of the background application above the foreground application, as shown in FIG. 5E. Note that scaled-down window 508 can be displayed translucently so that the contents of the section of window 502 underneath scaled-down window 508 remain visible. Also note that the contents within scaled-down window 508 do not have to be in focus. Even though the user may not understand the details of what the display renders, the user can easily recognize when any change occurs in scaled-down window 508.

Note that displaying a scaled-down window above the currently-running application window allows more efficient utilization of the display area for the currently-running application. Also note that the 3D animation effects described in FIGS. 5B-5D (and the stereo sound effects) can also be applied to scaled-down window 508 in FIG. 5E.

FIG. 5F illustrates using both miniaturized windows and scaled-down windows for the background-running applications in the same display area, wherein each window 504, 506, and 508 can utilize 3D animation effects independently to prompt the user for attention.

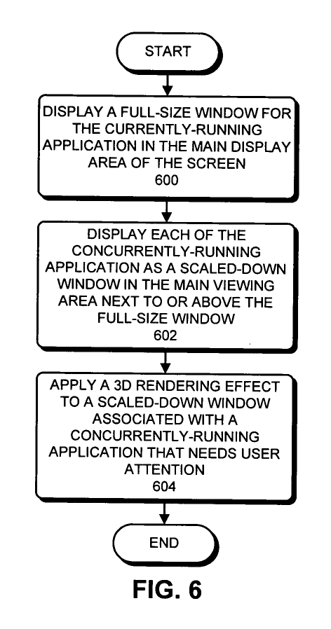

FIG. 6 presents a flowchart illustrating the process of enabling a concurrently-running application in the background to receive attention from the user who is interacting with a currently-running application in the foreground of the display area in accordance with an embodiment of the present invention.

During operation, the system displays a full-size window for the currently-running application in the main display area of the mobile device (step 600). Next, the system displays each of the concurrently-running applications as a scaled-down window in the same screen as the currently-running application window (step 602). Note that each of the scaled-down windows can be positioned so that they overlap (or do not overlap) the currently-running application window.

Next, when an application requires attention from the user, the system applies a 3D rendering effect to the associated window for that application to alert the user that the application requires attention (step 604).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for using three-dimensional (3D) and other rendering effects within a graphical display environment on a mobile device to enable a new application to be displayed while a currently-running application window remains visible within a main viewing area of a screen, the method comprising:
receiving a request to display a new application in the graphical display environment;
in response to the request, generating a slanted view of the currently-running application window by slanting the currently-running application window through a 3D rendering effect and moving the currently-running application window towards an edge of the screen to make room for the new application; and
displaying the new application in a new display window next to the slanted view of the currently-running application window.

2. The method of claim 1, wherein if the new application completes running before the currently-running application completes, the method further comprises:
closing the new display window for the new application in the main viewing area of the screen; and
restoring the currently-running application window back to original size, shape and position in the main viewing area of a screen.

3. The method of claim 1, wherein the new application is an interrupting application.

4. A method for using three-dimensional (3D) and other rendering effects within a graphical display environment on a mobile device to enable a second application which is displayed in the background of the graphical display environment to receive attention from a user who is interacting with a first application, the method comprising:
displaying a window for the first application in a main viewing area of the graphical display environment;
displaying a scaled-down window for the second application in the graphical display environment; and
when the second application requires attention, applying a 3D rendering effect to the displayed scaled-down window for the second application to alert the user that the second application requires attention.

5. The method of claim 4, wherein the scaled-down window for the second application in the graphical display environment is displayed next to the window for the first application in the main viewing area, wherein the scaled-down window is miniaturized.

6. The method of claim 4, wherein the scaled-down window for the second application in the graphical display environment is displayed so that the scaled-down window overlaps the window for the first application in the main viewing area, wherein the scaled-down window is translucent.

7. The method of claim 4, wherein the 3D rendering effect can include an animation action of the scaled-down window.

8. The method of claim 4, further comprising using a stereo sound effect associated with the location of the scaled-down window to alert the user that the second application requires attention.

9. The method of claim 4, further comprising using a vibration generator associated with the rendering effects to alert the user that the second application requires attention.

10. A computer-readable storage medium storing instructions that when executed by a computer cause the computer to perform a method for using three-dimensional (3D),and other rendering effects within a graphical display environment on a mobile device to enable a new application to be displayed while a currently-running application window remains visible within a main viewing area of a screen, the method comprising:
receiving a request to display a new application in the graphical display environment;
in response to the request, generating a slanted view of the currently-running application window by slanting the currently-running application window through a 3D rendering effect and moving the currently-running application window towards an edge of the screen to make room for the new application; and
displaying the new application in a new display window next to the slanted view of the currently-running application window.

11. The computer-readable storage medium of claim 10, wherein if the new application completes running before the currently-running application completes, the method further comprises:
closing the new display window for the new application in the main viewing area of the screen; and
restoring the currently-running application window back to original size, shape and position in the main viewing area of a screen.

12. The computer-readable storage medium of claim 10, wherein the new application is an interrupting application.

13. A computer-readable storage medium storing instructions that when executed by a computer cause the computer to perform a method for using three-dimensional (3D) and other rendering effects within a graphical display environment on a mobile device to enable a second application which is displayed in the background of the graphical display environment to receive attention from a user who is interacting with a first application, the method comprising:
displaying a window for the first application in a main viewing area of the graphical display environment;
displaying a scaled-down window for the second application in the graphical display environment; and
when the second application requires attention, applying a 3D rendering effect to the displayed scaled-down window for the second application to alert the user that the second application requires attention.

14. The computer-readable storage medium of claim 13, wherein the scaled-down window for the second application in the graphical display environment is displayed next to the window for the first application in the main viewing area, wherein the scaled-down window is miniaturized.

15. The computer-readable storage medium of claim 13, wherein the scaled-down window for the second application in the graphical display environment is displayed so that the scaled-down window overlaps the window for the first application in the main viewing area, wherein the scaled-down window is translucent.

16. The computer-readable storage medium of claim 13, wherein the 3D rendering effect can include an animation action of the scaled-down window.

17. The computer-readable storage medium of claim 13, wherein the method further comprises using a stereo sound effect associated with the location of the scaled-down window to alert the user that the second application requires attention.

18. The computer-readable storage medium of claim 13, further comprising using a vibration generator associated with the rendering effects to alert the user that the second application requires attention.

19. An apparatus that uses three-dimensional (3D) and other rendering effects within a graphical display environment on a mobile device to enable a new application to be displayed while a currently-running application window remains visible within a main viewing area of a screen, comprising:
a receiving mechanism configured to receive a request to display a new application in the graphical display environment;
a generation mechanism configured to generate a slanted view of the currently-running application window by slanting the currently-running application window through a 3D rendering effect and moving the currently-running application window towards an edge of the screen to make room for the new application in response to the request; and
a display mechanism configured to display the new application in a new display window next to the slanted view of the currently-running application window.

20. The apparatus of claim 19, further comprising:
a closing mechanism configured to close the new display window for the new application in the main viewing area of the screen; and
a restoring mechanism configured to restore the currently-running application window back to original size, shape and position in the main viewing area of a screen.

21. An apparatus that uses three-dimensional (3D) and other rendering effects within a graphical display environment on a mobile device to enable a second application which is displayed in the background of the graphical display environment to receive attention from a user who is interacting with a first application, comprising:
a display mechanism configured to display a window for the first application in a main viewing area of the graphical display environment;
wherein the display mechanism is additionally configured to display a scaled-down window for the second application in the graphical display environment; and
an applying mechanism configured to apply a 3D rendering effect to the displayed scaled-down window for the second application to alert the user that the second application requires attention.

22. The apparatus of claim 21, wherein the display mechanism is configured to display the scaled-down window for the second application in the graphical display environment next to the window for the first application in the main viewing area, wherein the scaled-down window is miniaturized.

23. The apparatus of claim 21, wherein the display mechanism is configured to display the scaled-down window for the second application in the graphical display environment so that the scaled-down window overlaps the window for the first application in the main viewing area, wherein the scaled-down window is translucent.
